(19) United States
(12) Patent Application Publication
(10) Pub. No.: US 2003/0004763 A1
(43) Pub. Date: Jan. 2, 2003

(54) Computerized systems and methods for the creation and sharing of project templates

(76) Inventors: Michael Robert LaBlanc, Wilton, NY (US); Leonard Richard Douglas, Burnt Hills, NY (US); Mark Mitchell Kornfein, Latham, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(21) Appl. No.: 09/681,946

(22) Filed: Jun. 29, 2001

(51) Int. Cl. G06F 17/60

(52) U.S. Cl. 705/7

(57) ABSTRACT

Computerized systems and methods for managing process compliance associated with a project including a project template module operable for creating, storing, and transmitting a plurality of project templates, a project compliance management module operable for receiving, storing, and searching a plurality of project templates, a processor operable for manipulating information related to the plurality of project templates, and a communications network operable for communicating information related to the plurality of templates to and from a plurality of remote users.

### BACKGROUND OF INVENTION

The present invention relates generally to computerized systems and methods for assuring process compliance for a wide array of processes and, more specifically, to web-based systems and methods for the creation and sharing of project templates.

Businesses utilize a variety of processes in their day-to-day operations. These processes may involve the completion of a number of discrete steps, forming a project. For example, businesses may utilize a variety of processes for bringing new products to market, often collectively referred to as new product introduction (NPI) processes. NPI processes may involve, for example, initial product conception, product design, product manufacture, and post-shipment follow-up. Typically, such processes include a series of tollgates, or go/no-go points. Each tollgate may include a set of activities and each set of activities may include a set of tasks. Typically, such processes also include a series of issues and risks which must be monitored, tracked, and addressed. While NPI processes are often very similar, they may be customized based upon the needs of a particular business or the requirements associated with a particular product. As a result, NPI processes may vary with respect to focus, steps, and nomenclature.

Traditionally, businesses have kept track of the steps comprising a project manually on paper, or with the aid of locally-accessible computer programs, such as spreadsheets and project management applications. Such systems and methods, however, have several important limitations. Such systems and methods are not generic and new papers or spreadsheets must be generated, for example, each time a new product is introduced, or when a new business utilizes an existing process.

Alternatively, when locally-accessible project management applications are used, information related to tollgates, activities, tasks, issues, and risks must be transferred from user to user via a computer-readable medium, such as on a diskette. Even then, simultaneous updates are not possible. In general, process compliance is difficult to ensure.

Limitations of even globally-accessible, web-based systems and methods include the inability to ensure that projects are created in a consistent manor, and that all required steps of the project are included. A further limitation of such systems and methods is that businesses have invested in legacy spreadsheet-based systems that are time consuming to manually load into a globally-accessible process compliance system.

Thus, what is needed are web-based systems and methods for easy capture, documentation, and maintenance of business processes in a globally-accessible system. What is also needed are systems and methods for the creation and sharing of project templates which are used for importing/exporting data into/out of a globally-accessible system in order to ensure that approved, generic processes are followed.

### SUMMARY OF INVENTION

The present invention overcomes the above limitations and provides systems and methods for the creation and sharing of project templates in order to monitor projects and ensure approved processes compliance.

In one embodiment, a computerized method for managing process compliance includes creating a project template, inputting project related information into the project template, transferring the project template to a globally-accessible system, searching and identifying projects within the globally-accessible system, and monitoring and tracking the projects using the globally-accessible system.

In another embodiment, a computerized system for managing process compliance includes a project template module operable for creating, storing, and transferring a project template into a globally-accessible system, a project compliance management module operable for receiving, storing, and searching the project template, a processor operable for manipulating information related to the project, and a communications network operable for communicating information related to the project to and from a plurality of remote users.

### BRIEF DESCRIPTION OF DRAWINGS

FIG. 1 is a flow chart of one embodiment of a computerized system for creating a project template and transferring project related data into a globally-accessible system;

FIG. 2 is a flow chart of one embodiment of a computerized method for managing the tollgates, activities, tasks, issues, and risks associated with a project;

FIG. 3 is a schematic diagram of one embodiment of a computerized system for managing the tollgates, activities, tasks, issues, and risks associated with a project;

and

FIG. 4 is a functional block diagram of one embodiment of a computer system including a project template module and a project compliance management module associated with a process compliance system.

### DETAILED DESCRIPTION

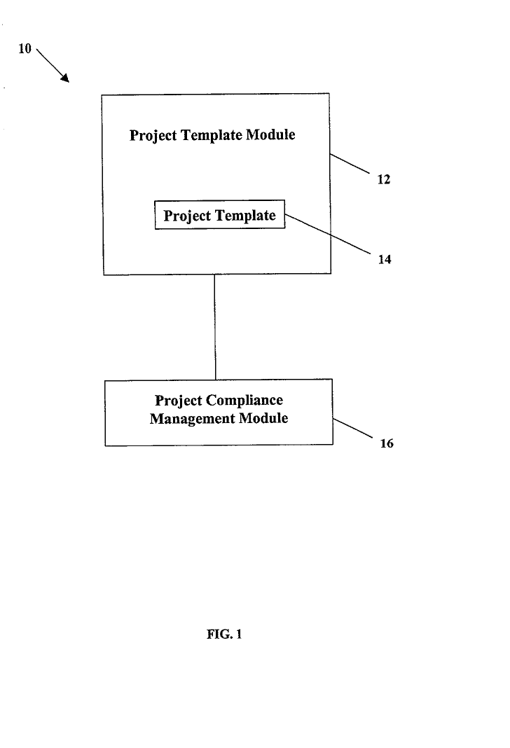

Referring to FIG. 1, in one embodiment, a computerized system 10 for inputting and transmitting project related data into a project compliance management module 16 for the purpose of managing and monitoring a project includes a project creator formatting or creating a project template 14 that may be inputted into the computerized system 10. When a new project is created, the project creator may select an appropriate template 14 from a list of existing templates. A project template module 12 automatically creates a new project template 14 in the computerized system 10. The templates are selected by project creators to facilitate the creation of projects in a computerized process compliance system of which a web-based NPI system is an example. Selecting the template may create all of the projects associated tollgates, activities, tasks, issues, and risks. The project template 14 allows the creator to schedule and assign tollgates, activities, tasks, issues, and risks. The project template module 12 allows for the transfer of the project related data to a project compliance management module 16, which may be utilized to assist in the management of a predetermined project.

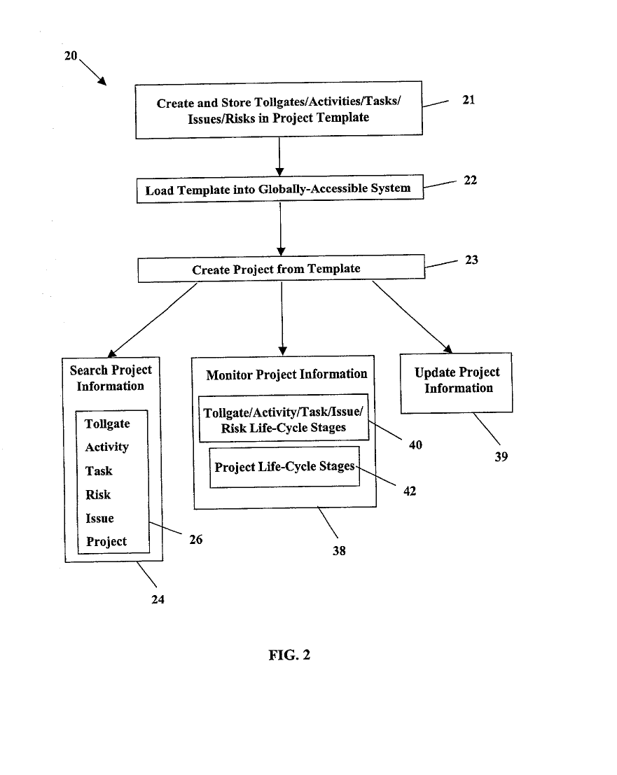

Referring to FIG. 2, in one embodiment, a computerized method 20 for managing process compliance associated with a project allows a remote user to log into a globally-accessible system and create and store project-related information such as tollgates, activities, tasks, issues, and risks 21. A project template 14 is selected and information is entered. The template 14 is loaded into a globally-accessible system 22 and a project is created 23 from the template. The project may be searched 24, monitored 38, and updated 39. The globally-accessible system preferably includes a web page which contains or is in communication with a project compliance management module 16 and a project template module 12. The web page is preferably secure and may include a plurality of dynamic menus, drop-down lists, links, and the like displayed on a graphical user interface. Through the web page, a project creator, a project leader, a project manager, a team member, an activity or task performer, or any other authorized remote user may view information, submit information, and query the system. After a project template 14 has been created and stored, the project template module 12 transfers/receives data to/from the project compliance management module 16. The data may include information such as tollgates, activities, tasks, issues, and risks. The data may further include project identification information such as name, business location, name of data file, user name, where in the database the information is going to go, and any additional field. Once a project template 14 is selected, the template 14 is used to create a project. The project template 14 allows the tollgates, activities, tasks, issues, and risks to be inputted in a standard way which ensures uniform quality and consistency among projects. Once a project is created using a selected template 14, the data may be used to search among one or a plurality of projects, search within one or a plurality of projects, or identify a project based upon predetermined criteria 26. Predetermined criteria may include any aspect of a project that a user of the system may inquire about. Once a tollgate, activity, task, issue, risk, or project has been searched and identified 24, its status may be monitored 38, tracked, and updated 39 by a remote user 52. For example, the project compliance management module 16 may allow the status of a tollgate, activity, task, issue, or risk to be tracked over its life-cycle 40, or over the life-cycle of a given project 42.

The project template 14 operates as a pattern for a project. By selecting a template 14 from a list of predetermined templates, the project creator is provided with a list of a project's associated information. As discussed above, information may be related to tollgates, activities, tasks, issues, risks, names, or any other project related information. The project template 14 may be used for keeping track of project-related information and the steps associated with a project. The information may be provided to the creator by the template 14, or information may be manually added, deleted, and updated. The project template 14 ensures that project quality remains consistent by providing users with process guidelines provided in the templates 14.

In one embodiment of the present invention, the template 14 includes one or a plurality of spreadsheets. An example of a suitable spreadsheet application includes Microsoft Excel™ (Microsoft Corporation, Redmond, Wash.). The spreadsheet allows for the capture, documentation, and maintenance of project processes. Information contained within the spreadsheet is imported into the project compliance management module 16, where the information may be monitored and managed for process compliance.

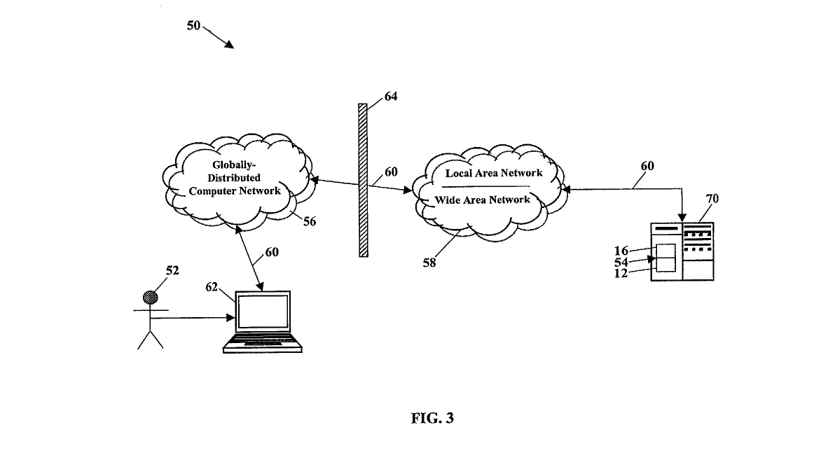

Referring to FIG. 3, in one embodiment, a computerized system 50 for project management includes a remote user 52 linked to a project management web page 54 via a globally-distributed computer network 56, such as the Internet or an intranet, and/or a local area network/wide area network (LAN/WAN) 58. This link may be established along one or more data communication lines 60, or via wireless interfaces. The remote user 52 may view, submit, and query information at the project management web page 54 through a browser application run by a computer 62, such as a desktop or laptop personal computer. Through the project management web page 54, the remote user 52 is linked, through a firewall 64, to the project compliance management module 16 (FIG. 1) and the project template module 12 (FIG. 1) which operate on project-related data. The project management web page 54 may reside in a persistent storage device 70, such as an application server, a web server, a file server, or a database server. The system 50 is set up such that the server 70 may communicate information to and acquire information from a plurality of remote users 52 simultaneously.

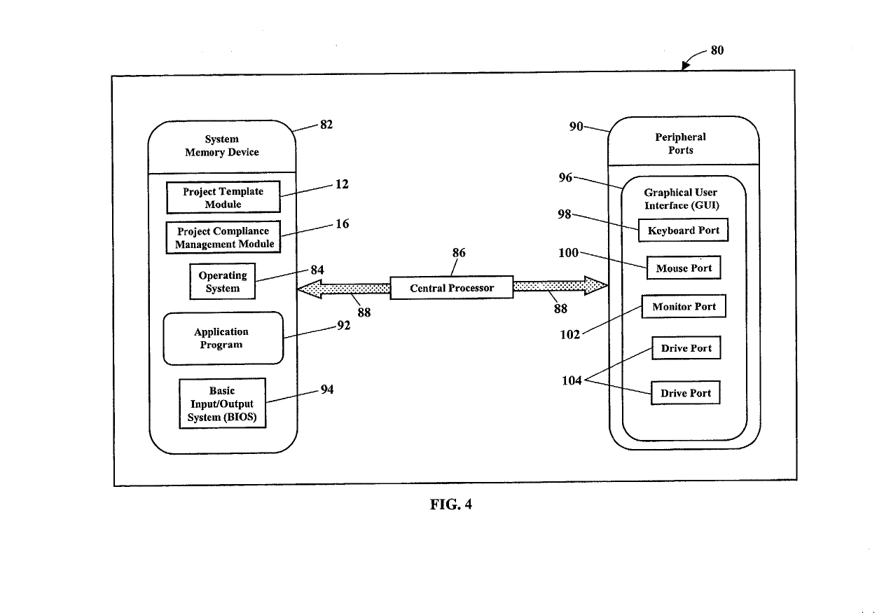

Referring to FIG. 4, in one embodiment, the project compliance management module 16 (FIG. 1) and project template module 12 (FIG. 1) comprise one or more computer programs which acquire project-related data, store and archive the data, manipulate the data, and formulate outputs which may be viewed and queried by the remote user 52 (FIG. 3). The project compliance management module 16 and project template module 12 preferably reside within the system memory device 82 of a computer system 80, which may, optionally, be an application server, a web server, a file server, or a database server. The system memory device 82 may include a random-access memory (RAM) and a read-only memory (ROM). The system memory device 82 may also include other types of memory, such as programmable read-only memory (PROM), erasable programmable read-only memory (EPROM), and electrically erasable programmable read-only memory (EEPROM). The system memory device 82 also preferably includes an operating system 84 that executes on a central processor 86. The central processor 86 may be, for example, a microprocessor. Suitable examples of microprocessors include, but are not limited to, those manufactured by Advanced Micro Devices, Inc. (Sunnyvale, Calif.), Intel Corporation (Santa Clara, Calif.), Motorola, Inc. (Schaumburg, IL), International Business Machines Corp. (Armonk, N.Y.), and Transmeta Corp. (Santa Clara, Calif.). The central processor 86 may include an arithmetic logic unit (ALU), which performs arithmetic and logic operations, and a control unit, which extracts instructions from the system memory device 82. The operating system 84 may include a set of instructions which control the internal functions of the computer system 80. For example, the operating system 84 may recognize input from input devices, send output to output devices, keep track of directories and files, and control various peripheral devices. Suitable examples of operating systems 84 include, but are not limited to, those manufactured by Sun Microsystems, Inc. (Palo Alto, Calif.), Microsoft Corporation (Redmond, Wash.) and Apple Computer, Inc. (Cupertino, Calif.). A system bus 88 may communicate signals, such as address signals, data signals, and control signals, between the system memory device 82, the central processor 86, and one or more peripheral ports 90. The system memory device 82 may also contain an application program 92 and a basic input/output system (BIOS) 94. The application program 92 cooperates with the operating system 84 and the one or more peripheral ports 90 to provide a graphical user interface (GUI) 96. The GUI 96 typically includes a combination of signals communicated along a keyboard port 98, a mouse port 100, a monitor port 102, and one or more drive ports 104. The BIOS 94 may interpret requests from the operating system 84 and interface with such ports to execute the requests. Accordingly, suitable input/output devices include a keyboard, a mouse, a monitor, a printer, a plotter, speakers, etc.

The systems, methods, programs, and processes described in relation to the present invention are not limited to any particular computer system. The computer system 80 may be a single device, or it may be a plurality of devices working in concert. The computer system 80 may take the form of a hand-held digital computer, a personal computer, a workstation, a server, a mainframe computer, and a supercomputer.

As discussed above, functionally, the computerized system 50 (FIG. 3) for project management allows a remote user 52 (FIG. 3) to enter project information into a globally-accessible system 50 via a plurality of spreadsheets. The globally-accessible system 50 preferably includes a web page 54 (FIG. 3) which contains or is in communication with the project template module 12 (FIG. 1) and the project compliance management module 16 (FIG. 1). The system 50 also allows a plurality of remote users 52 to simultaneously access, view, and update project-related information. Advantageously, the system enables non-information technology (IT) personnel to use standard spreadsheet software to develop NPI templates. The system also enables an NPI developer to define optional and required work units within an overall process.

It is apparent that there has been provided, in accordance with embodiments of the present invention, web-based systems and methods for project management using spreadsheet templates to transfer project related data. While the present invention has been particularly shown and described in conjunction with preferred embodiments thereof, it will be appreciated that variations in and modifications to the present invention may be effected by persons of ordinary skill in the art without departing from the spirit or scope of the present invention. For example, the computerized systems and methods of the present invention may be used for assuring process compliance for a wide array of processes, not simply those related to new product introductions. Further, it is to be understood that the principles described herein apply in a similar manner, where applicable, to all preferred embodiments.

1. A computerized method for ensuring process compliance associated with a project, the method comprising:
creating a project template;
inputting project-related information into the project template;
transferring the project template to a globally-accessible system;
searching and identifying projects within the globally-accessible system; and
monitoring and tracking the projects using the globally-accessible system.

2. The method of claim 1, wherein the project template comprises one or a plurality of spreadsheets.

3. The method of claim 1, wherein the globally-accessible system comprises a globally-distributed computer network.

4. The method of claim 1, further comprising storing the project information within the globally-accessible system.

5. The method of claim 1, wherein the project related information comprises any of tollgates, activities, tasks, issues, and risks.

6. The method of claim 1, wherein the project related information further comprises any of project name, business location, data file name, user name, location of information within a database, and any additional field.

7. The method of claim 1, wherein monitoring and tracking the projects further comprises managing and tracking the projects through the life-cycle of the projects.

8. The method of claim 1, wherein the globally-accessible system may be accessed by a plurality of remote users simultaneously.

9. A web-based method for ensuring process compliance associated with a project, the method comprising:
creating a project template, wherein the project template comprises one or a plurality of spreadsheets;
inputting project-related information into the project template;
transferring the project template to a globally-accessible system;
storing the project template within the globally-accessible system;
searching and identifying projects within the globally-accessible system; and
monitoring and tracking the projects using the globally-accessible system.

10. The method of claim 9, wherein the globally-accessible system comprises a globally-distributed computer network.

11. The method of claim 9, wherein the project related information comprises any of tollgates, activities, tasks, issues, and risks.

12. The method of claim 9, wherein the project related information further comprises any of project name, business location, data file name, user name, location of information within a database, and any additional field.

13. The method of claim 9, wherein monitoring and tracking the projects further comprises managing and tracking the projects through the life-cycle of the projects.

14. The method of claim 9, wherein searching and identifying projects further comprises searching one or more projects based on predetermined criteria.

15. A computerized system for ensuring process compliance associated with a project, the system comprising:
a project template module operable for creating, storing, and transferring a project template;
a project compliance management module operable for receiving, storing, and searching the project template;
a processor operable for manipulating information related to the project; and
a communications network operable for communicating information related to the project to and from a plurality of remote users.

16. The system of claim 15, wherein the project template comprises one or a plurality of spreadsheets.

17. The system of claim 15, wherein the communications network comprises a globally-distributed computer network.

18. The system of claim 15, wherein the project template module is operable for creating a new project template from a list of existing templates.

19. The system of claim 15, wherein the project template module is operable for creating a new project template.

20. The system of claim 15, wherein the project template module is operable for transmitting the project template to the project compliance management module.

21. The system of claim 15, wherein the project compliance management module is operable for receiving and monitoring the project template.

22. The system of claim 15, wherein the project compliance management module is operable for searching for a project based upon predetermined criteria.

23. The system of claim 15, wherein the project compliance management module is operable for monitoring and tracking the project template through the life-cycle of each project.

24. The system of claim 15, wherein the communications network is operable for communicating information related to the project template to and from a plurality of remote users simultaneously.
